(19) United States
(12) Patent Application Publication
(10) Pub. No.: US 2005/0186853 A1
(43) Pub. Date: Aug. 25, 2005

(54) Connector

(75) Inventors: Han-Cheng Hsu, Taoyuan Hsien (TW); Chih-Tse Chen, Taoyuan Hsien (TW); Ching-Man Kao, Taoyuan Hsien (TW)

Correspondence Address: BIRCH STEWART KOLASCH & BIRCH, PO BOX 747, FALLS CHURCH, VA, 22040-0747, US

(73) Assignee: Delta Electronics, Inc.

(21) Appl. No.: 11/062,457

(22) Filed: Feb. 22, 2005

(30) Foreign Application Priority Data
Feb. 24, 2004 (TW) 93104657

(51) Int. Cl. H01R 24/00

(52) U.S. Cl. 439/676

(57) ABSTRACT

A connector is described. The connector prevents erroneous insertion of a non-corresponding plug. The connector has a housing, a plug and a stopper. The stopper is positioned at the front of the housing to prevent the housing from an erroneous insertion of a non-corresponding plug. The stopper comprises a supporting member and a protrusion formed on the supporting member. The connector further utilizes the stopper to avoid erroneous insertion.

### RELATED APPLICATIONS

The present application is based on, and claims priority from, Taiwan Application Serial Number 93104657, filed Feb. 24, 2004, the disclosure of which is hereby incorporated by reference herein in its entirety.

### FIELD OF THE INVENTION

The present invention relates to a connector, and more particularly to an RJ-45 connector.

### BACKGROUND OF THE INVENTION

Due to highly developed information technology, electrical and information products are more popular and convenient for users. Computer systems and peripherals thereof progress greatly, day by day, and people can search for information and provide services with networks. Via networks, people enjoy a comfortable and fast information search environment.

The wide proliferation of personal computers and networks allows people to utilize networks to search for and provide information. Currently, small quantities of computers and concentrated computers cannot provide enough information and data for business utilization. In a normal company, the computer system is distributed and connected by the network to provide enough service and information for business requirements. Hence, a personal computer, a notebook computer, or even a handheld computer provides an interface to connect to the network.

The computer apparatuses connected to the networks are usually connected to the network directly or through a relative electrical device, for example, a hub with connectors. Conventional and popular connectors for connecting to the network are a pair of a connector, for example an RJ-45 connector and an RJ-45 plug. The RJ-45 connectors are commonly used for network cabling while the RJ-11 connectors are for telephony applications. However, the appearance and dimensions of the RJ-45 connector are similar to that of an RJ-11 connector; the RJ-11 connector is slightly smaller than the RJ-45 connector. Therefore, the RJ-45 connector for network and the RJ-11 for telephone are always disposed adjacently.

Hence, because the RJ-11 connector is smaller than the RJ-45 connector, the RJ-11 plug is very easily inserted into the RJ-45 connector by mistake. Therefore, the electrical equipment with the RJ-11 plug cannot work and/or the network signals are interfered with, and further the electrical equipment can be damaged by a mistake.

### SUMMARY OF THE INVENTION

It is an objective of the present invention to provide a connector to avoid insertions of a non-corresponding plug into the wrong connector so as to avoid electrical equipment damage and network interference as caused by a mistake.

It is another objective of the present invention to provide an RJ-45 connector to avoid insertion of a non-RJ-45 connector therein, and especially, to avoid the insertion of an RJ-11 plug into the RJ-45 connector.

To accomplish the above objectives, the present invention provides a connector to avoid erroneous insertion of a non-corresponding connector. For example, an RJ-45 connector prevents the insertion of an RJ-11 or RJ-12 plug effectively. The connector has a housing, a plug, and a stopper. The housing has a receiving hole. The plug is inserted into the receiving hole. The stopper is positioned at the front of the housing to prevent erroneous insertion of the non-corresponding plug.

The stopper is preferably disposed at the front position of the housing and slightly extending into the receiving hole. The stopper comprises a plurality of protrusions respectively positioned at both front sides of the housing. The connector also utilizes a plurality of protrusion disposed at front positions of the housing. For the RJ-45 connector, a height of the protrusion is preferably less than about 0.5 mm.

The stopper is formed on the housing or placed between the housing and the metal shell. The connector utilizes the stopper effectively to avoid erroneous insertion of the non-corresponding connector, and especially to prevent insertion of an RJ-11 or RJ-12 plug into an RJ-45 connector. Therefore, the network environment will be more stable without erroneous insertion and the electrical equipment will work more safely.

### BRIEF DESCRIPTION OF THE DRAWINGS

The foregoing aspects and many of the attendant advantages of this invention are more readily appreciated as the same becomes better understood by reference to the following detailed description, when taken in conjunction with the accompanying drawings, wherein:

FIG. 1 is a first preferred embodiment of a connector according to the present invention;

FIG. 2 is a second preferred embodiment of a connector according to the present invention; and

FIG. 3 illustrates positions of a stopper of the first and second preferred embodiment.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

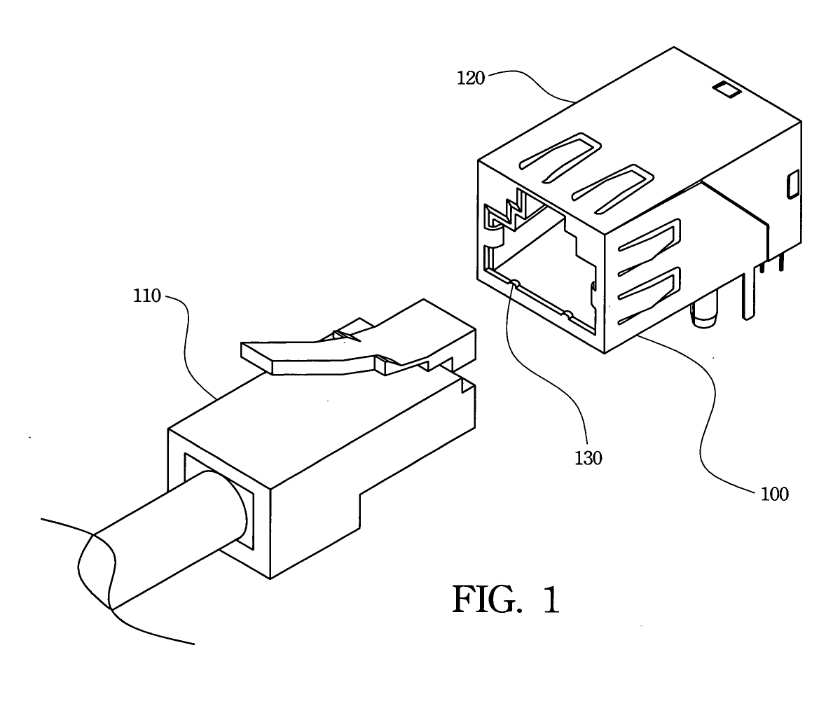

FIG. 1 illustrates a first preferred embodiment of a RJ-45 connector according to the present invention. The RJ-45 connector 120 comprises a plug 110 and a housing 120. There is an open on the housing called a receiving hole. The housing is covered by a metal shell 100. When connected, the plug 110 is plugged into the housing 120 through the receiving hole. In this embodiment, an RJ-45 connector 120 has a stopper 130 directly formed on the housing.

The stopper 130 comprises at least one protrusion slightly extending into the receiving hole of the housing 120. The stopper 130 can be set at all positions at the front on the housing 120 or be placed between the housing 120 and the metal shell 100 to prevent an erroneous insertion of the non-RJ-45 plug, for example, an RJ-11 plug, an RJ-12 plug or the like. The stopper 130 allows insertion of a standard RJ-45 plug 110 and prevents insertion of a non-RJ-45 plug, for example, an RJ-11 plug.

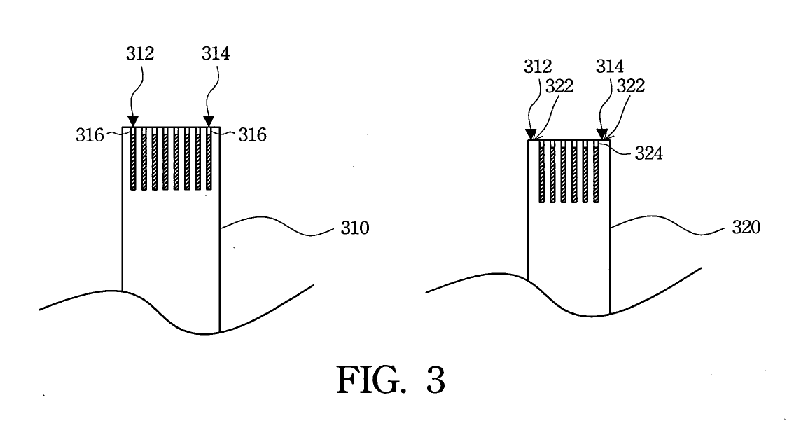

FIG. 3 illustrates positions of protrusion of the RJ-45 connector according to the present invention. A left portion of FIG. 3 illustrates a standard RJ-45 plug 310 and a right portion thereof illustrates a standard RJ-11 plug 320.

The stopper of the first preferred embodiment shown in FIG. 3 can be placed at the housing corresponding to both position 312 and/or position 314 of the plug 310, or more positions of the corresponding housing. The plug 310 has eight pins. The position 312 and the position 314 are the positions of the bilateral front sides of RJ-45 plug 310; that is to say, the stopper 130 is placed corresponding to positions of the first and the eighth pins of the plug 310 while the plug 310 is inserted into the receiving hole. Therefore, while the RJ-45 plug 310 is inserted into the RJ-45 connector, the stopper may pass through grooves 316 of the RJ-45 plug 310 so that the RJ-45 plug 310 can smoothly couple to the RJ-45 connector. A height of the stopper is less than a depth of the grooves 316 of the plug 310, and is preferably less than about 0.5 mm.

To avoid the RJ-11 plug 320 to be inserted into the RJ-45 connector 120, an end portion 322 of the RJ-11 plug 320 must be stopped by the stopper 130. The RJ-11 plug 320 is smaller and has only six grooves 324, however, the stopper 130 is placed at the bilateral front sides of the housing. Thus, the RJ-11 plug 320 is stopped by the stopper 130 and cannot be inserted into the RJ-45 connector 120.

The stopper comprises a supporting member and a protrusion formed on the supporting member to prevent the housing from any erroneous insertion. To avoid an erroneous insertion of a non-corresponding plug, a stopper is disposed on the housing or between the housing and the metal shell. The stopper is coupled to the housing by welding, clicking, embedding, hooking, or being formed integrally. The metal shell covering the housing can then be connected to chassis or earth ground so as to prevent EMI from entering or leaving the connector housing.

Hence, the RJ-45 connector can effectively avoid an erroneous insertion of the non-RJ-45 plug, especially a RJ-11 plug and a RJ-12 plug. Therefore, the RJ-45 connector according to the present invention can prevent a non-RJ-45 plug from coupling with the RJ-45 housing. Accordingly, the network can effectively keep away from the non-corresponding electrical equipment and the electrical equipment can avoid damage to be caused by an erroneous insertion.

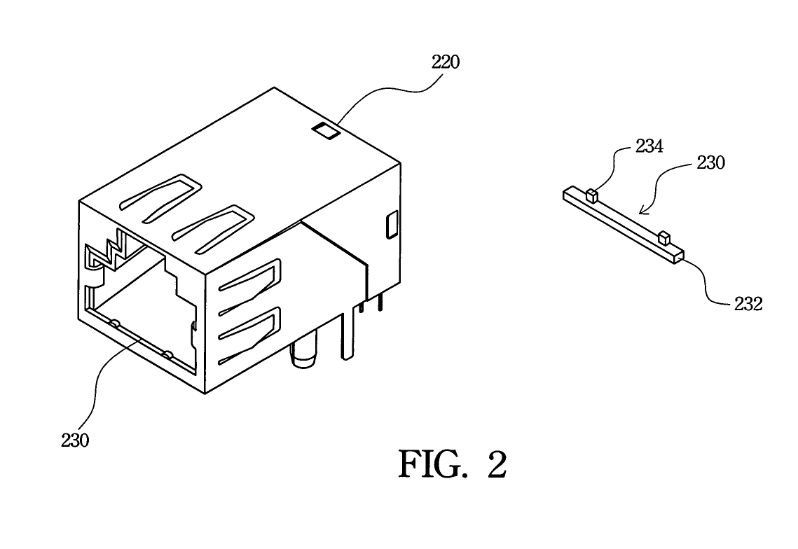

FIG. 2 is a second preferred embodiment of a connector according to the present invention. The RJ-45 connector 220 has a stopper 230 disposed in front of the RJ-45 connector 220 to avoid the insertion of the non-RJ-45 plug. The stopper 230 includes a supporting member 232 and protrusions 234. The positions of the protrusion 234 are disposed at the position 312, the position 314 of FIG. 3, or both the positions 312 and 314, or additional protrusion disposed at any other positions to prevent from erroneous insertion of the non-RJ-45 plug.

The RJ-45 connector of the foregoing preferred embodiment utilizes the stopper to prevent erroneous insertion of a non-RJ-45 plug, and the stopper can be directly formed on the housing of the RJ-45 connector or formed on a separate stopper that can be installed on the RJ-45 connector. The stopper can couple to the housing of the connector by welding, clicking in, embedding, hooking, or formed integrally. Therefore, a non-RJ-45 plug, and especially an RJ-11 plug, can be effectively prevented from coupling with the RJ-45 connector. The connector can reduce the network interference caused by erroneous insertion, and enhance the network equipment stability and the safety of the electrical equipment.

The connector according to the present invention can be used for the RJ-45 connector or any similar connector, and especially for the connectors for computers and communications to improve erroneous insertion of the connectors. Accordingly, the connector according to the present invention can reduce erroneous insertion and further reduce the electrical equipment damage.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

1. A connector, comprising:
a housing having a receiving hole;
a plug for being inserted into the receiving hole;
a stopper positioned at the front of the housing to prevent the housing from an erroneous insertion of a non-corresponding plug.

2. The connector of claim 1, wherein the stopper comprises at least one protrusion slightly extending into the receiving hole.

3. The connector of claim 1, wherein the housing is covered by a metal shell.

4. The connector of claim 3, wherein the stopper is formed on the housing or placed between the housing and the metal shell.

5. The connector of claim 1, wherein the stopper comprises a plurality of protrusions respectively positioned at bilateral front sides of the housing.

6. The connector of claim 5, wherein the plug has eight pins and the stopper is placed corresponding to positions of a first and an eighth pins of the plug while the plug is inserted into the housing.

7. The connector of claim 1, wherein a height of the stopper is less than the depth of a groove of the plug.

8. The connector of claim 1, wherein a height of the stopper is less than about 0.5 mm.

9. The connector of claim 1, wherein the stopper is coupled to the housing by welding, clicking, embedding, hooking, or being formed integrally.

10. The connector of claim 1, wherein the stopper comprises a supporting member and a protrusion formed on the supporting member.

11. A connector, comprising:
a housing having a receiving hole;
an RJ-45 plug for being inserted into the receiving hole;
a stopper positioned at the front of the housing to prevent the housing from an erroneous insertion of a non-corresponding plug.

12. The connector of claim 11, wherein the non-corresponding plug is an RJ-11 plug or an RJ-12 plug.

13. The connector of claim 11, wherein the stopper comprises at least one protrusion slightly extending into the receiving hole.

14. The connector of claim 11, wherein the housing is covered by a metal shell.

15. The connector of claim 14, wherein the stopper is formed on the housing or placed between the housing and the metal shell.

16. The connector of claim 11, wherein the stopper comprises a plurality of protrusions respectively positioned at front sides of the housing.

17. The connector of claim 11, wherein the RJ-45 plug has a plurality of pins and the stopper is placed corresponding to at least one pin of the RJ-45 plug while the RJ-45 plug is inserted into the housing.

18. The connector of claim 11, wherein the stopper is coupled to the housing by welding, clicking, embedding, hooking, or being formed integrally.

19. The connector of claim 11, wherein the stopper comprises a supporting member and a protrusion formed on the supporting member.
